(19) United States
(12) Patent Application Publication
(10) Pub. No.: US 2024/0015796 A1
(43) Pub. Date: Jan. 11, 2024

(54) UE COVERAGE ENHANCEMENTS

(71) Applicant: FRAUNHOFER-GESELLSCHAFT ZUR FÖRDERUNG DER ANGEWANDTEN FORSCHUNG E.V., München (DE)

(72) Inventors: Thomas Fehrenbach, Berlin (DE); Baris Goktepe, Berlin (DE); Sarun Vanesan, Berlin (DE); Thomas Wirth, Berlin (DE); Thomas Schierl, Berlin (DE); Cornelilus Hellge, Berlin (DE); Nithin Srinivasan, Berlin (DE)

(21) Appl. No.: 18/022,277

(22) PCT Filed: Aug. 17, 2021
(86) PCT No.: PCT/EP2021/072813

§ 371 Date: Feb. 21, 2023

(30) Foreign Application Priority Data
Aug. 28, 2020 (EP) 20193444.5

(51) Int. Cl. H04W 74/08

(52) U.S. Cl. CPC H04W 74/0833

(57) ABSTRACT

A user device, UE, for a wireless communication network, is described. During a random access, RACH, procedure, the UE signals a type of the UE.

The present invention concerns the field of wireless communication networks or systems. Embodiments concern a coverage enhancement of a user device or a UE in a wireless communication network. Further embodiments concern the identification of a UE type or a UE category of a user device or UE of a wireless communication network by other entities in the network, like a base station.

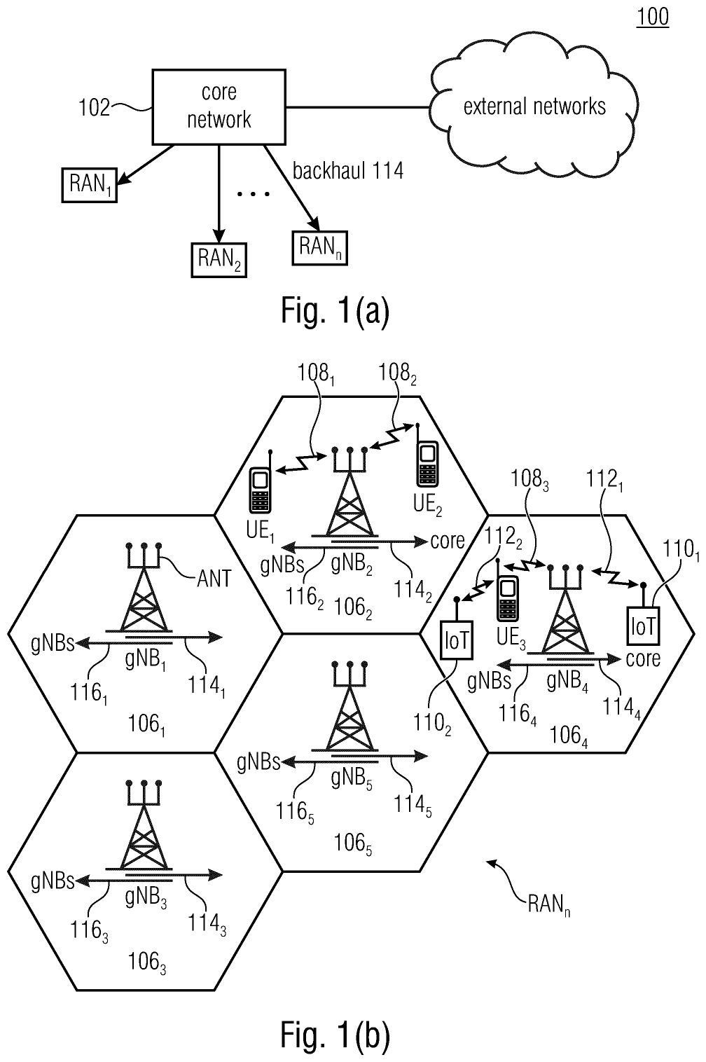

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 1121. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 1161 to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length. For example, in 5G a subframe has a duration of 1 ms, as in LTE. The subframe includes one or more slots, dependent on the subcarrier spacing. For example, at a subcarrier spacing of 15 kHz the subframe includes one slot, at a subcarrier spacing of 30 kHz the subframe includes two slots, at a subcarrier spacing of 60 kHz the subframe includes four slots, etc. Each slot may, in turn, include 12 or 14 OFDM symbols dependent on the cyclic prefix, CP, length.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

In a wireless communications network, like the one described above with reference to FIG. 1, several types or categories of user devices or UEs may be employed. For example, there are so-called full-powered UEs that are provided with a permanent power supply, like vehicular UEs obtaining power from a vehicle's battery. For such UEs, energy consumption is not an issue. Other user devices or UEs, like hand-held UEs, pedestrian UEs (P-UEs) or remote. sensors, do not have a permanent power supply but are battery driven so that energy consumption needs to be considered. Also, there may be so-called Reduced Capability, RedCap, user devices or UEs having less capabilities when compared to other UEs, e.g., to enhanced Mobile BroadBand, eMBB, UEs. The capabilities concerned may include a maximum bandwidth such a UE may support. For example, when operating in Frequency Range 1, FR1, the UE may support a maximum of 20 MHz bandwidth, and when operating in Frequency Range 2, FR2, the UE may support up to 100 MHz bandwidth. Yet other capabilities may include a maximum transmit power being less than a maximum transmit power of the other UEs, a data processing power being less than a data processing power of the other UEs, a processing time for processing data, like blind decoding of data or processing data received or to be transmitted or preparing of a transmission or processing of HARQ feedback, e.g. PSFCH, being longer than a processing time of the other UEs, a downlink or uplink or sidelink supported data rate or throughput being less than that of other UEs, or an end-to-end delay being larger than that of other UEs, and/or a power supply capability being less than a power supply capability of the other UEs.

Further requirements of a RedCap UE may include one or more of the following:
Device complexity: reduced costs and complexity when compared to high-end eMBB and Ultra Reliable Low Latency Communication, URLLC, devices.
Device size: for most use cases device design with compact form factor is required.
Deployment scenarios: support of all FR1/FR2 bands for Frequency Division Duplexing, FDD, and Time Division Duplexing, TDD.

RedCap UEs may comprise also industrial sensors for industrial IoT (IIoT)-devices, or wearables using SL communication to communicate with other UEs directly. For example, wearables may use SL communication to communicate with cars or other wearables directly, e.g. a smartwatch communicating with a smartphone or a smartwatch using a smartphone as a relay to a gNB.

It is noted that the information in the above section is only for enhancing the understanding of the background of the invention and, therefore, it may contain information that does not form prior art that is already known to a person of ordinary skill in the art.

Starting from the above, there may be a need for improvements or enhancements for user devices having reduced capabilities.

Embodiments of the present invention are now described in further detail with reference to the accompanying drawings:

FIG. 1 is a schematic representation of an example of a terrestrial wireless network, wherein FIG. 1(a) illustrates a core network and one or more radio access networks, and FIG. 1(b) is a schematic representation of an example of a radio access network RAN;

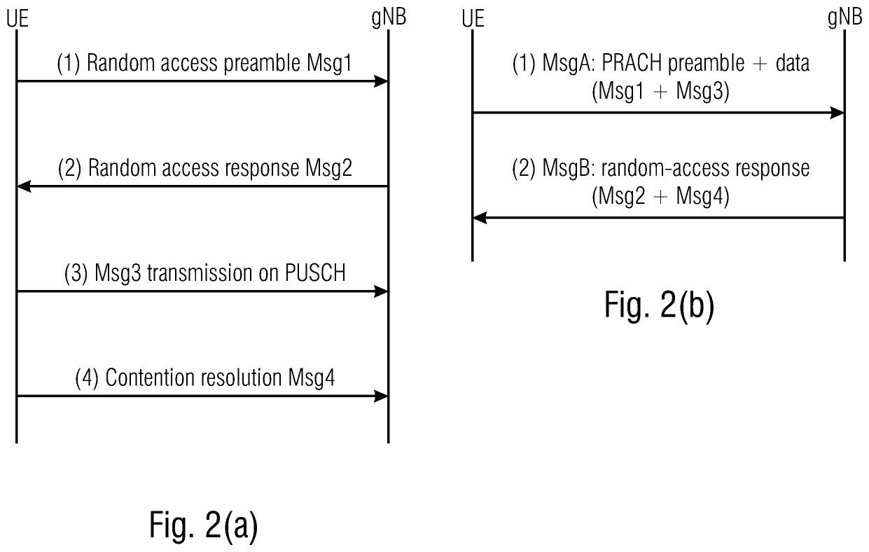

FIG. 2 FIG. 2 illustrates examples of a conventional NR RACH process, wherein FIG. 2(a) illustrates a 4-step RACH procedure, and FIG. 2(b) illustrates a 2-step RACH procedure;

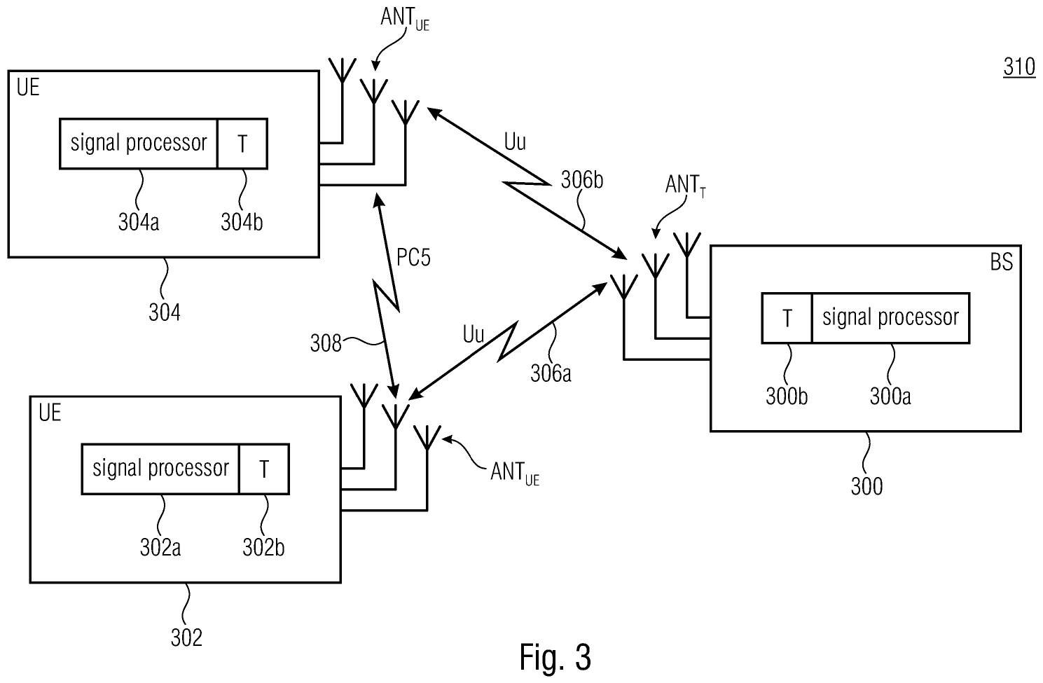

FIG. 3 is a schematic representation of a wireless communication system including a transmitter, like a base station, and one or more receivers, like user devices, UEs, for implementing embodiments of the present invention;

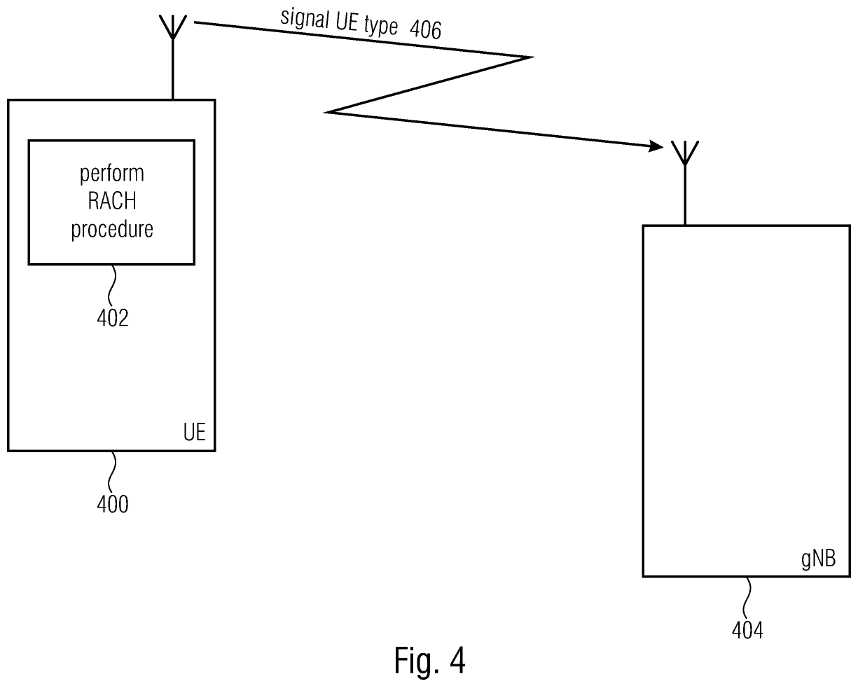

FIG. 4 illustrates a user device in accordance with embodiments of a first aspect of the present invention;

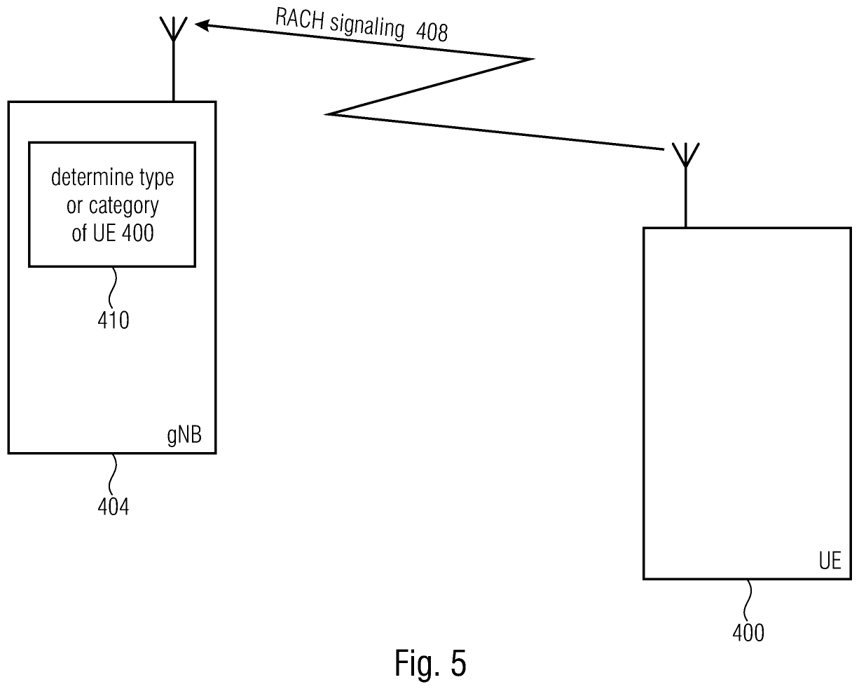

FIG. 5 illustrates a base station in accordance with embodiments of the first aspect of the present invention;

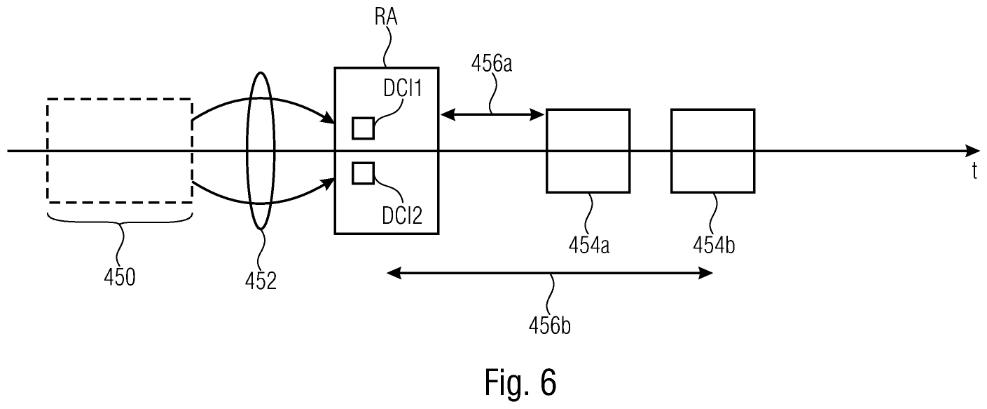

FIG. 6 illustrates extending the time gap between a control message and an associated uplink grant responsive to determining the type of a UE performing a RACH procedure in accordance with embodiments of the first aspect of the present invention;

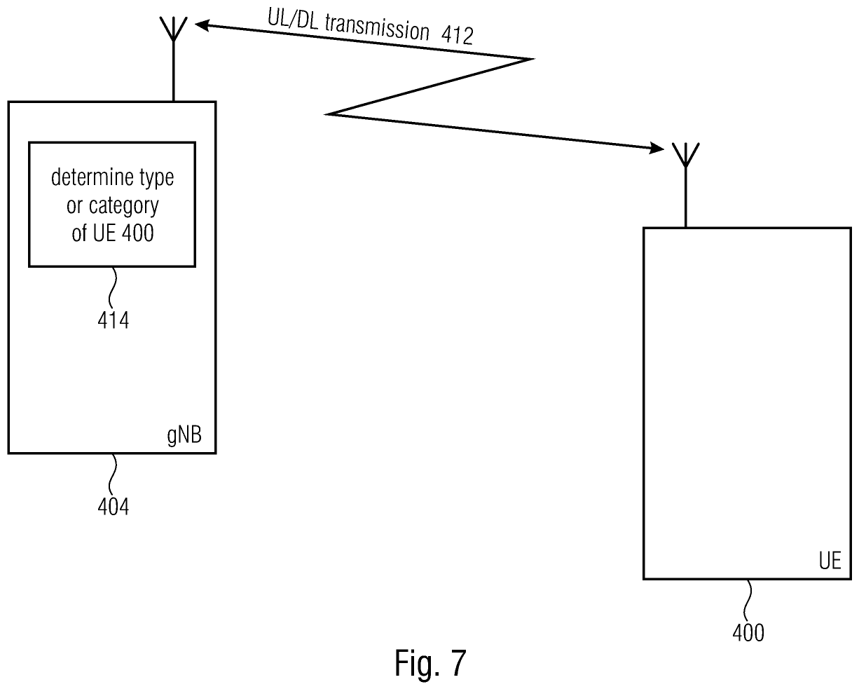

FIG. 7 illustrates a user device in accordance with embodiments of a second aspect of the present invention;

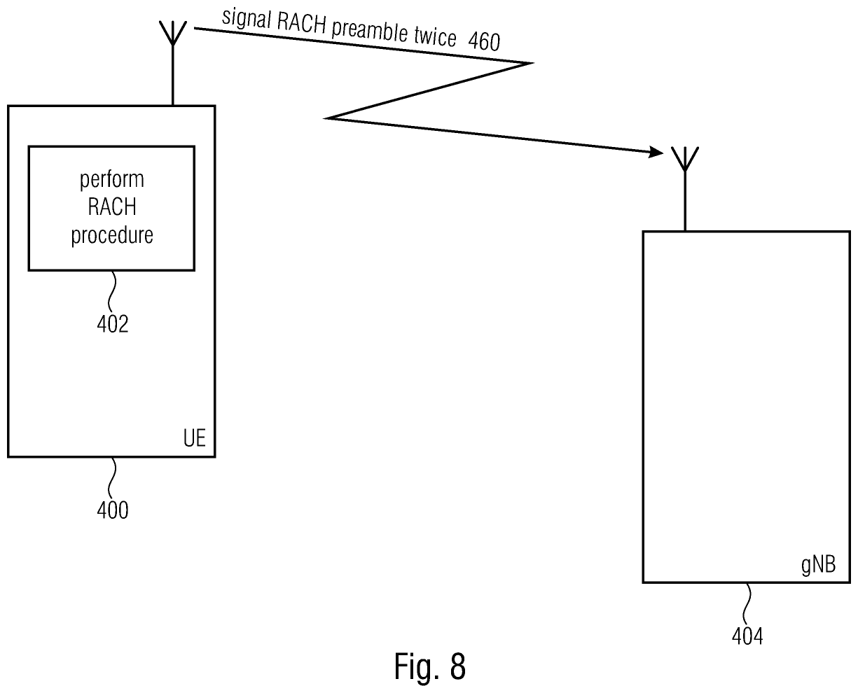

FIG. 8 illustrates a user device in accordance with embodiments of a third aspect of the present invention;

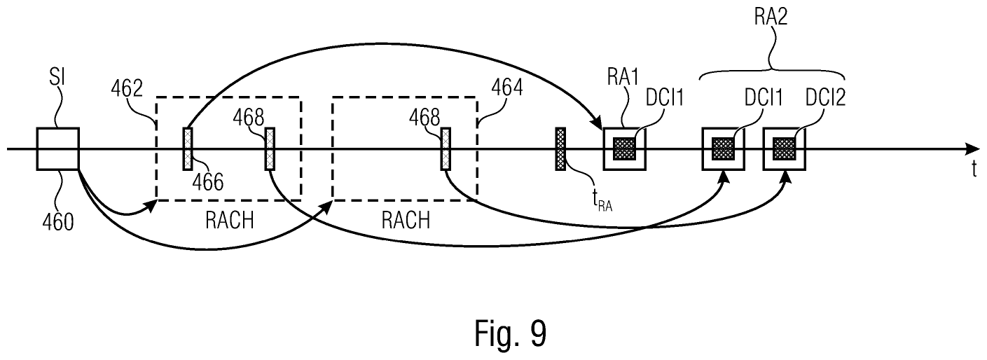

FIG. 9 illustrates a low power or extended coverage RACH mode in accordance with embodiments of the third aspect of the present invention; and

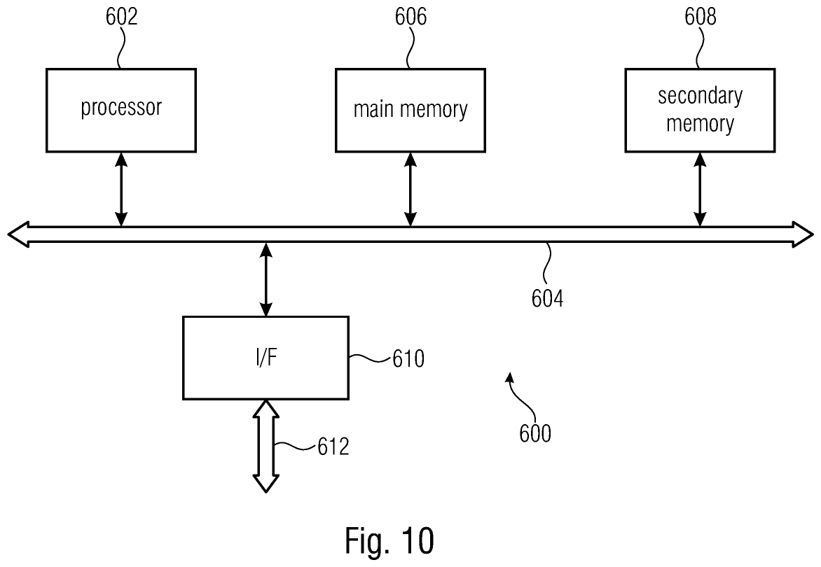

FIG. 10 illustrates an example of a computer system on which units or modules as well as the steps of the methods described in accordance with the inventive approach may execute.

Embodiments of the present invention are now described in more detail with reference to the accompanying drawings, in which the same or similar elements have the same reference signs assigned.

In a wireless communication network as described above with reference to FIG. 1, UEs having, when compared to other UEs, like an eMBB UE, reduced capabilities may be employed, like the above-described reduced capability UEs or RedCap UEs. When being in a connected state, like the RRC_CONNECTED state, a UE having reduced capabilities may be managed by the communication network which, at this time, is aware of the UE type or category and the associated limitations. In other words, once the radio access network or base station knows the UE type or category, all signaling between the reduced capability UE and the base station is performed such that the reduced capabilities of the UE connected to the base station are taken into account. For example, when the reduced capability leads to more time for decoding or processing data, like control data or payload data, received from the radio access network, certain processes, like a HARQ feedback process, may require more time than when communicating with a UE without such reduces capabilities, like an eMBB UE.

However, during initial access of a UE to the network, for example, when the UE is carrying out a random access, RACH, procedure, the radio access network or base station, at this time, is not aware of the UE type or UE category of the UE performing the initial access routine.

The initial access routine to be performed by the UE may start with the UE searching for synchronization or sync signals, like the primary synchronization signal, PSS, or the secondary synchronization signal, SSS, or in response to a handover command. Once the synchronization signals are found, a downlink synchronization is obtained and system information, SI, is decoded by the UE, like the system information block, SIB, or the master information block, MIB, or this information is provided by the source gNB. Following this, the UE performs a random access, RACH, procedure which may include sending a RACH message, receiving a RACH response, a potential contention resolution, and an uplink synchronization and the reception of a UL grant. NR supports a 4-step RACH procedure and a 2-step RACH procedure, as is illustrated in FIG. 2. FIG. 2(a) illustrates the 4-step RACH procedure, and FIG. 2(b) illustrates the 2-step RACH procedure.

In a first step of the 4-step RACH procedure illustrated in FIG. 2(a), a random access preamble, Msg1, is transmitted by the UE to the base station or gNB. In a second step, the random access response, Msg2, is transmitted from the gNB to the UE. After sending the preamble, the UE monitors the PDCCH for a random access response, and responsive to receiving the RA response, the UE in step 3 sends uplink scheduling information, Msg3. Responsive to sending Msg3, in step 4 a contention resolution may be performed.

The 2-step RACH procedure may be employed, and the UE combines Msg1 and Msg3 of the 4-step RACH procedure into one message, like message MsgA, and transmits MsgA to the base station. The base station, as is illustrated in FIG. 2(b) combines Msg3 and Msg4 of the 4-step RACH procedure and sends MsgB as a response to the UE. Conventionally, combining the messages of the RACH procedure in the 2-step process is used for certain applications and services, like low-latency applications and services, to provide a low-latency RACH procedure.

Conventionally, reduced capability UEs are required to perform a full initial access and a full RACH procedure, as it is also carried out by other UEs not having reduced capabilities. However, performing a full initial access and RACH procedure does not allow for a reduction of the power consumption as it is desired when operating UEs with the reduced capability. Another conventional approach for addressing the above-mentioned issue regarding the unknown UE category upon an initial access routine may be to treat all UEs in the network as UEs having reduced capabilities and employing appropriate RACH procedures. However, this leads to a situation in which also those UEs having sufficient capabilities for performing a regular RACH procedure need to perform the modified RACH procedure, which takes more time and this may be not acceptable for certain types of UEs, like URLLC UEs that need to register to the network quickly.

The present invention addresses the above issue and provides, in accordance with various aspects, approaches for improving the identification of a UE category or type at a time when the UE performs an initial access routine.

In a wireless system as described above with reference to FIG. 1, as mentioned above, different types of UEs having different capabilities may be employed. Such UEs, for initially accessing the wireless communication network, may perform an initial access routine, like a RACH procedure, however, there may be situations in which the UE does not reach the radio access network or base station during the initial access routine. For example, a reduced capability UE may have a limited transmit power so that a RACH message that is transmitted by the RedCap UE does not reach the radio access network or reaches the network with a bad quality so that it may not be identified or decoded at the base station. Such a situation may also occur when a regular UE, i.e. a UE having capabilities that are higher than the capabilities of a RedCap UE is employed but is located in a scenario in which a radio link to a base station is bad, for example, when placing a sensor device including a UE within a building so that only a poor channel to the radio access network exists. In other words, there may be situations in a network, like the one of FIG. 1, in which an initial access routine is difficult to perform in view of a reduced coverage of the UE performing the access routine.

The present invention addresses this issue and provides, in accordance with further aspects, approaches improving the coverage of a UE in a wireless communication network during an initial access routine, like a RACH procedure.

Embodiments of the present invention may be implemented in a wireless communication system as depicted in FIG. 1 including base stations and users, like mobile terminals or IoT devices. FIG. 3 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink, SL, interface. When the UEs are not served by the base station or are not connected to a base station, for example, they are not in an RRC connected state, or, more generally, when no SL resource allocation configuration or assistance is provided by a base station, the UEs may communicate with each other over the sidelink, SL. The system or network of FIG. 3, the one or more UEs 302, 304 of FIG. 3, and the base station 300 of FIG. 3 may operate in accordance with the inventive teachings described herein.

First Aspect—UE Category of Type Identification During a Random Access Procedure

User Device

The present invention provides a user device, UE, for a wireless communication network, wherein, during a random access, RACH, procedure, the UE is to signal a type of the UE.

In accordance with embodiments, the UE is to
initially send a RACH message at least twice, or
send a certain RACH message that is associated with the type of the UE, or
send a RACH message including information indicating the type of the UE.

In accordance with embodiments, the UE is to initially send a RACH message at least twice during a time period in which the UE does not expect a response to the RACH message from a base station of the wireless communication network, e.g., over the Uu interface, or from another UE of the wireless communication network, e.g., over the sidelink interface.

In accordance with embodiments, the UE is to initially send the RACH message, like a Msg1 or a MsgA or redundancy versions thereof, in one or more of
the time domain,
the frequency domain,
the space domain,
the code domain.

In accordance with embodiments, the RACH message to be initially sent is a RACH preamble, and the UE is to
obtain from system information, SI, one or more RACH resource sets, and
send the RACH preamble more than once using one or more of the RACH resource sets.

In accordance with embodiments, the certain RACH message comprises a RACH preamble associated with the type of the UE.

In accordance with embodiments, the UE is to select the RACH preamble from a set of RACH preambles associated with the type of the UE.

In accordance with embodiments, the RACH preamble or the set of RACH preambles associated with the type of the UE is predefined, e.g., by a standard specification, or wherein the UE is to receive a signaling indicating the RACH preamble or the set of RACH preambles associated with the type of the UE, e.g., a system information block, SIB, or a master information block, MIB, or a broadcast message, like an RRC configuration message or by a unicast or groupcast or broadcast message via a sidelink interface, e.g. PC5, from another UE.

In accordance with embodiments, the RACH procedure is a four-step RACH procedure or a two-step RACH procedure.

In accordance with embodiments, the RACH procedure is a two-step RACH procedure and the UE is to include the information indicating the type of the UE into MsgA of the two-step RACH procedure.

In accordance with embodiments, the type of the UE comprises or indicates one or more of:
a UE capability,
a UE supporting a special service, like a reduce capability, RedCap, UE, a Public Protection and Disaster Relief, PPDR, UE, an Internet-of-Things, IoT, UE, an industrial Internet-of-Things, IIoT,
a vehicular UE,
a pedestrian UE,
a relay UE.

Apparatus

The present invention provides an apparatus for a wireless communication network, wherein, during a random access, RACH, procedure of a UE in the wireless communication network, the apparatus is to determine whether the UE is of a certain type.

In accordance with embodiments, the apparatus is to determine that the UE is of the certain type responsive to receiving
at least n transmissions of a RACH message from the UE, n being an integer greater than 1, or
a certain RACH message that is associated with the certain type of the UE, or
a RACH message including information indicating the certain type of the UE.

In accordance with embodiments, the certain RACH message comprises a RACH preamble associated with the type of the UE.

In accordance with embodiments, the UE is to select the RACH preamble from a set of RACH preambles associated with the type of the UE.

In accordance with embodiments, the RACH preamble or the set of RACH preambles associated with the type of the UE is predefined, e.g., by a standard specification, or wherein the UE is to receive a signaling indicating the RACH preamble or the set of RACH preambles associated with the type of the UE, e.g., a system information block, SIB, or a master information block, MIB, or a broadcast message, like an RRC configuration message or by a unicast or groupcast or broadcast message via a sidelink interface, e.g. PC5, from another UE.

In accordance with embodiments, the RACH procedure is a two-step RACH procedure and the apparatus is to extend a timing between MsgA and MsgB responsive to receiving in MsgA information indicating that the UE is of the certain type.

In accordance with embodiments, responsive to determining that the UE is of the certain type, the apparatus is to increase a time gap between sending a control message, like a DCI, to the UE and sending associated data, like a PDSCH.

In accordance with embodiments, responsive to determining that the UE is of the certain type, the apparatus is to increase a time gap between sending a control message, like a DCI or a SCI, to the UE and an associated grant for a transmission.

In accordance with embodiments, in case the apparatus is not able to determine the type of UE, the apparatus is to indicate a grant or data such that the data can be transmitted or processed by a UE of the certain type and by a UE of a different type.

In accordance with embodiments, in case the apparatus is not able to determine the type of UE, the apparatus is to indicate two or more grants or two or more data allocations such that at least a UE of the certain type can transmit or process data associated with one of the grants or data allocations and a UE of a different type can transmit or process data associated with another of the grants or data allocations.

In accordance with embodiments, the apparatus comprises a user device, UE, or a base station of the wireless communication network, or a relay node or relay, or a relay-UE.

Method

The present invention provides a method for operating a user device, UE, for a wireless communication network, the method comprising signaling, during a random access, RACH, procedure, a type of the UE.

The present invention provides a method for operating an apparatus for a wireless communication network, the method comprising, during a random access, RACH, procedure of a UE in the wireless communication network, determining whether the UE is of a certain type.

In accordance with embodiments of the first aspect of the present invention, the issue is addressed that a radio access network or base station is not aware of a UE category or UE type when the UE is performing an initial access routine, like a RACH procedure, by identifying or determining the UE category or UE type during a random access, RACH, procedure. FIG. 4 illustrates an embodiment of the first aspect of the present invention, and shows a user device 400, that, as is indicated at 402, performs an initial access routine for connected to a wireless communication network, like a RACH procedure. As is described above with reference to FIG. 2, during the RACH procedure, the UE 400 sends messages to the gNB or base station 404 and in accordance with the first aspect of the present invention, during the RACH procedure 402, the UE 400 also signals its category or type to the gNB 404, as is indicated at 406.

FIG. 5 illustrates an embodiment of the first aspect of the present invention illustrating a base station or gNB 404 that receives from a UE, like UE 400, a signaling 408 associated with an initial access procedure, like a RACH signaling as is described above with reference to FIG. 2. As is illustrated at 410, the base station 404, during such a random access, RACH, procedure, of the UE 400 determines whether the UE is of a certain type.

In accordance with embodiments of the first aspect of the present invention, to signal the type or category of the UE 400, the UE 400 may initially send a RACH message at least twice, like Msg1 of the 4-step RACH procedure or MsgA of the 2-step RACH procedure. in accordance with embodiments, rather than sending the same message again, also redundancy versions thereof may be transmitted following the first transmission. In accordance with embodiments, the RACH message is sent twice, however, it may also be sent more often. Responsive to sending the initial RACH message, the UE 400 expects receiving, after a certain period of time lapsed, the RA response from the base station 404. In accordance with the inventive approach, during this period of time, i.e. during the time in which the UE does not expect receiving the RA response from the gNB, the RACH message is sent or transmitted multiple times, i.e. twice or more often, to the base station. It is noted that the UE repeats the RACH message, i.e. the same message is sent twice or more often.

In accordance with embodiments, the RACH message may be transmitted by the UE 400 multiple times either at different times during the time domain, at different frequencies in the frequency domain, using different beams in the space domain, or using messages being coded in a different way. Also, combinations of these transmissions may be employed so that the RACH message is sent multiple times in one or more of the time domain, the frequency domain, the space domain, and the code domain.

In accordance with other embodiments, when performing the RACH procedure, the UE 400, may derive from the system information, like the MIB or the SIB, one or more RACH resource sets to be used for a transmission of the RACH message, like the RACH preamble, and the UE sends the RACH preamble more than once using one or more of the obtained RACH resource sets. In accordance with embodiments, the RACH resource sets may be in the same domain or may be in different domains.

In accordance with other embodiments, the RedCap UE can be configured by another UE via SL to perform this RedCap RACH procedure. This can be signaled to the RedCap UE via sidelink control channel, PSCCH, using 1^{st} or 2^{nd} stage sidelink control information (SCI) or via sidelink data channel, PSSCH, using MAC control elements (MAC CEs).

In accordance with other embodiments, the exact RedCap RACH procedure or configuration may be hardcoded within the RedCap UE. Furthermore, this modified RACH procedure may be only activated, when certain conditions occur, e.g. if the link budget (Maximum Coupling Loss (MCL), MIL=MCL+antennas gain components of gNB and UE, Maximum Path Loss (MPL)) is within a certain range, the RedCap UE performs this modified RACH procedure, otherwise, it performs the normal 2-step RACH or 4-step RACH procedures.

Responsive to sending the multiple RACH preambles, the base station 404 recognizes that the UE performing the RACH procedure is a UE having reduced capabilities, i.e. by receiving within the time period before sending out the RA or RACH response, multiple RACH preambles, the gNB or base station 404 determines the UE to be of a certain type, like a reduced capability type, so that the gNB 404 may adapt its further operations to the reduced capabilities of the UE.

In accordance with embodiments, the base station 404 may make the response, like the RA response, more robust by repeating the RA response, i.e., by sending the RA or RACH response twice or more, e.g., in one or more of the time, frequency, code or spatial domains.

In accordance with further embodiments of the first aspect of the present invention, the UE 400 may signal the UE type during the RACH procedure by sending a certain RACH message that is associated with the type of the UE. In accordance with embodiments, the certain RACH message may comprise a RACH preamble that is associated with the type or category of the UE. The UE may select the RACH preamble from a set of RACH preambles associated with the type or category of the UE 404. In accordance with embodiments, the RACH preamble or the set of RACH preambles associated with the type or category of the UE may be predefined, for example, may be defined in a standard on the basis of which the wireless communication network operates so that the respective preambles are known to all entities of the network. In accordance with other embodiments, the UE 404 may receive a signaling indicating the RACH preamble or the set of RACH preambles associated with certain types of UEs, so that the UE may select a preamble corresponding to its type or category and signal the selected RACH preamble to the base station. This signaling may be a signaling of system information, like the SIB or the MIB, or may be a broadcast message, like an RRC configuration message.

The base station 404, when receiving from the UE 400 the certain RACH message, like the RACH preamble associated with the type of UE, on the basis of this information, determines the type of UE 400 performing the RACH procedure.

In accordance with yet further embodiments of the first aspect of the present invention, the UE may send a RACH message which includes information indicating the type of the UE. In accordance with embodiments, the UE may employ a two-step RACH procedure as described above with reference to FIG. 2 which allows transmitting small amounts of data during the initial RACH transmission in message MsgA. In accordance with embodiments of the present invention, this possibility is employed for signaling during the first RACH message MsgA the type or category of the UE 400 by including into the MsgA an information indicating the type of the UE. The base station 404, responsive to receiving MsgA determines from the data included in the MsgA the type of the UE.

As described above, certain UEs, like RedCap UEs, may require a longer processing time, for example, due to a reduced processing power, for blind decoding, PDSCH processing, PUSCH preparation and/or PSFCH processing than other UEs with higher processing capabilities. Thus, a time gap between receiving a DCI and an associated PDSCH, a PDSCH and the associated HARQ feedback or a DCI and the associated PUSCH or a PSFCH and a PUCCH needs to be longer when compared to that of an eMBB UE, and the base station or gNB, accommodates for this fact by identifying the UE as a RedCap UE during the RACH procedure in a way as described above in more detail. Once the base station 404 determined or identified that the UE is of a certain type, it may accommodate to the respective capabilities of the UE. In accordance with embodiments, when the HARQ procedure is a two-step procedure, the base station 404 may extend the timing between MsgA and MsgB responsive to receiving in MsgA the information that the UE is of a certain type. In other words, the two-step RACH procedure may be adapted for RedCap devices. While, originally, the two-step RACH procedure was introduced for low latency devices, also RedCap devices benefit from the reduced signaling procedure used in the two-step RACH procedure by informing the bases station MsgA about its type, thereby allowing the base station to adjust the timing between MsgA and MsgB, for example, by stretching the time period or extending.

In accordance with further embodiments, responsive to determining that the UE is of a certain type, the base station 404 may increase a time gap between sending a control message, like a DCI, and an associated uplink grant. Thus, when the UE performing the RACH procedure is identified to be a reduced capability UE, by extending the time gap it is made sure that the reduced capability UE has sufficient time for decoding the DCI and learning about the resources for the uplink grant. Likewise, in accordance with further embodiments, also the time gap between sending the DCI and sending a PDSCH may be extended, again, to give the reduced capability UE sufficient time for decoding the DCI and determining where the downlink transmission is to be expected.

In accordance with embodiments, in case the base station is not capable to determine during the RACH procedure the type or category of the UE performing the RACH procedure, the base station may send data, like control data and/or payload data to the UE in such a way that it may be processed by different types or categories of UEs. For example, in such a situation, the base station may extend the gap between sending a control message and a downlink message or an uplink grant so as to accommodate for the capabilities of the UE having the most reduced capabilities in the system. This ensures that also in situations in which no identification of the type of UE is possible, also such reduced capability UEs may be connected to the system. The actual type of the UE may be determined once the UE is connected, e.g., by requesting or acquiring the UE capability information from the UE once it is in the RRC connected state. In accordance with another embodiment, the BS may indicate two or more grants or two or more data allocations or two or more HARQ reporting occasions such that at least a UE of the certain type may can transmit or process data associated with one of the grants or data allocations and a UE of a different type can transmit or process data associated with another of the grants or data allocations FIG. 6 illustrates an example for extending the time gap between a control message, like a DCI, and an associated uplink grant responsive to determining the type of a UE performing the initial access procedure, like the RACH procedure. In FIG. 6, the initial messages of the RACH procedure are schematically illustrated at 450, i.e., the transmission of the RACH preamble or the like by the UE to the gNB 404 which, based on the messages determines the type of UE. The base station 404, as is illustrated at 452 returns the RA response including a DCI which, in turn, is associated with an uplink grant for transmitting data from the UE to the base station. In case the base station 404 determines the UE to be a first type, the like an eMBB UE, a DCI 1 is transmitted in the RA response scheduling a UL grant 454A with a first time gap 456a between the DCI and the actual uplink grant. In case the base station determines the UE to be a reduced capability UE, a DCI 2 is transmitted in the RA scheduling a uplink grant 454b having a time gap 456b with reference to the DCI or RA that is extended when compared to the time gap 456a for the first type of UE to allow the RedCap UE sufficient time for decoding the DCI using its reduced processing capabilities.

Second Aspect—Determining a Type or Category of the UE Responsive to Transmissions

Apparatus

The present invention provides an apparatus for a wireless communication network, wherein, responsive to a transmission between the apparatus and a UE in the wireless communication network, the apparatus is to determine whether the UE is of a certain type.

In accordance with embodiments, the transmission is a transmission from the UE to the apparatus, and wherein the apparatus is to
send to the UE data, like one or more DCIs or SCIs, indicating one or more grants, like an UL grant or a SL grant,
determine, using a timing of a transmission by the UE, whether the UE is of the certain type.

In accordance with embodiments, the one or more is to send one DCI or SCI including the plurality UL or SL grants, or a plurality of DCIs or SCIs, each including a UL or SL grant, and the respective UL or SL grants are associated with respective processing times that may be employed in the wireless communication network for processing data, like blind decoding of data or processing data received or to be transmitted, the plurality of processing times including a first processing time to be used by a UE of a first type and a second processing time to be used by a UE of a second type.

In accordance with embodiments, the transmission is a transmission from the apparatus to the UE, and wherein the apparatus is to
send to the UE first data, like a first PDSCH/PSSCH or a first DCI/SCI, and second data, like a second PDSCH/PSSCH or a second DCI/SCI,
determine, using a timing of a feedback, like a HARQ feedback, whether the UE is of the certain type.

In accordance with embodiments, the transmission is a transmission from the apparatus to the UE, and wherein the apparatus is to
send to the UE data, like a PDSCH/DSSCH or a DCI/SCI, and
determine, using a timing of a feedback, like a HARQ feedback, whether the UE is of the certain type.

In accordance with embodiments, the apparatus comprises a user device, UE, or a base station of the wireless communication network, or a relay node or relay, or a relay-UE.

Method

The present invention provides a method for operating an apparatus for a wireless communication network, the method comprising, responsive to a transmission between the apparatus and a UE in the wireless communication network, determining whether the UE is of a certain type.

In accordance with embodiments of the second aspect of the present invention, the category or type of the UE may also be determined or identified by a base station without requesting the UE capabilities but from the behavior of the UE connected to the base station during uplink or downlink transmissions. FIG. 7 illustrates an embodiment of the second aspect of the present invention showing a base station 404 communicating with a UE 400 by sending uplink/downlink transmissions 412. As is indicated at 414, the base station 404 responsive to an uplink transmission or a downlink transmission determines whether the UE 400 is of a certain type.

For example, in case of an uplink transmission from the UE 400 to the base station 404, the base station 404 sends to the UE 400 downlink control data, like one or more DCIs, indicating one or more uplink grants. Responsive to the actual uplink transmission, more specifically to a timing of the uplink transmission, the base station may determine the type of the UE or whether the UE is of a certain type expected. In accordance with such embodiments, the UE 400 may select a processing time to be employed according to its capability, like a short processing time for an eMBB UE and a longer processing time for a RedCap UE. The processing times available in the system may be provided via the system information, SI, or may be transmitted by the base station during the RACH procedure in Msg2 or Msg4. The UE selects its processing time, and the base station monitors the time period between sending a DCI scheduling an uplink grant and the actual uplink transmission so that based on the timing an eMBB UE is identified in case the processing time is below a certain threshold, and a UE with reduced capabilities is assumed in case the time period between the DCI and the actual uplink transmission is above the certain threshold.

In accordance with other embodiments, rather than obtaining the processing time from the system information or the like, the base station may transmit multiple DCIs containing normal and extended processing time uplink grants. For the extended processing time uplink grants, a cross-slot scheduling configuration may be preconfigured with the UEs, e.g., a DCI schedules a PDSCH not in the same slot but in a next or another subsequent slot. Dependent on the actual transmission from the UE, the gNB determines whether the UE is of a first type or a second type, for example, is an eMBB UE using the normal processing time uplink grant or is a reduced capability UE using the extended processing time uplink grant.

In accordance with other embodiments, the transmission may be a downlink transmission from the base station 404 to the UE 400, and the base station may send first downlink data, like a first PDSCH or a first DCI, and second downlink data, like a second PDSCH or a second DCI, and determine, dependent on a timing of a feedback, like the HARQ feedback, whether the UE is of a certain type. The PDSCH is associated with a DCI that includes or indicates a field or value associated with a time period until which a feedback, like a HARQ feedback, is to be send. For example, an eMBB UE receiving the DCI may interpret the value or field indicating the time period until the feedback is to be sent to be a first, a short time period, like 2 ms, while a RedCap UE understands the same field to mean a time period of a longer duration, like 20 ms. Thus, responsive to sending one or more DCIs to the UE, the gNB monitors the timing until when the feedback, like the HARQ feedback, is received and, in case the HARQ feedback is received within the shorter time period, the gNB determines the UE to be an eMBB UE, while determining the UE to be a RedCap UE in case the feedback is received later.

Third Aspect—UE Coverage Enhancement

User Device

The present invention provides a user device, UE, for a wireless communication network, wherein, during a random access, RACH, procedure, the UE is to initially send a RACH message at least twice.

In accordance with embodiments, the UE is to initially send the RACH message at least twice during a time period in which the UE does not expect a response to the RACH message from a base station of the wireless communication network, e.g., over the Uu interface, or from another UE of the wireless communication network, e.g., over the sidelink interface.

In accordance with embodiments, the UE is to monitor one or more control channels for a control message, like a DCI or a SCI, scrambled with an Radio Network Temporary Identifier for the RACH procedure, like an RA-RNTI, only after sending the second RACH message.

In accordance with embodiments, the UE supports a first maximum transmit power, the first maximum transmit power being less than a second maximum transmit power of one or more further UEs in the wireless communication network.

In accordance with embodiments, the UE is to repeat the RACH message, like a Msg1 or a MsgA or redundancy versions thereof, in one or more of
the time domain,
the frequency domain,
the space domain,
the code domain.

In accordance with embodiments, the RACH message to be repeated is a RACH preamble, and the UE is to
obtain one or more RACH resource sets, and
send the RACH preamble more than once using one or more of the RACH resource sets.

In accordance with embodiments, the UE is to receive a signaling indicating the one or more RACH resource sets, e.g., a system information block, SIB, or a master information block, MIB, or a broadcast message, like an RRC configuration message or by a unicast or groupcast or broadcast message via a sidelink interface, e.g. PC5, from another UE.

Method

The present invention provides a method for operating a user device, UE, for a wireless communication network, the method comprising, during a random access, RACH, procedure, initially sending a RACH message at least twice.

In accordance with embodiments of a third aspect of the present invention, an approach is provided allowing the enhancement of a coverage of a UE during an initial access procedure, for example, in case the UE has reduced capabilities so that, for example, a transmit power may not be sufficient for transmitting RACH messages during the initial procedure to the gNB in a reliable way, or in case a UE with normal capabilities is located such that a radio quality to the base station is poor, so that the RACH messages may not be reliably transmitted.

FIG. 8 illustrates a UE 400 performing, in a similar way as the UE in FIG. 4, a RACH procedure as is illustrated in 402. The RACH procedure includes transmitting RACH messages to a base station 404, and in accordance with embodiments of the third aspect of the present invention, the UE, during the RACH procedure, initially sends a RACH message at least twice as is indicated at 460. As explained above with reference to FIG. 2, during a RACH procedure, the UE expects to receive a RACH response, RA response, from the gNB, and in accordance with embodiments of the third aspect of the present invention, during the time before the RA response is expected, the UE transmits the same RACH message multiple times. Repeating the RACH message, for example, repeating Msg1 or MsgA or redundancy versions thereof, allows UEs operating in a low power mode to reliably transmit the RACH message to the base station or allow regular UEs to increase the coverage, for example, in case they are located in a position in which a link quality to the base station is poor. As described above with reference to the first aspect of the present invention, the repetition of the RACH message may be in the time domain and/or in the frequency domain and/or in the space domain and/or in the code domain.

For example, the UE may monitor one or more control channels for a DCI scrambled with an Radio Network Temporary Identifier for the RACH procedure, RA-RNTI, only after sending a second RACH message. In case of a sidelink communication, the UE may monitor one or more sidelink control channels for a SCI scrambled with an Radio Network Temporary Identifier for the RACH procedure.

FIG. 9 illustrates an embodiment of the third aspect of the present invention for a low power or extended coverage RACH mode. The UE, initially, at 460 obtains system information and derives from the system information one or more sets of RACH resources at which transmissions of a RACH preamble are possible. FIG. 9 illustrates a first set of RACH resources 462 and a second set of RACH resources 464. When operating in a regular mode, i.e. not in a low power or extended coverage mode, the UE may select the RACH resources 462 and send a RACH preamble as is indicated at 466 in response to which a DCI 1 is transmitted by the gNB at a time after t_{RA} in a RACH response RA1. The DCI may be in a CORESET (Control Resource Set). When operating in the low power or extended coverage mode, the UE selects the RACH resource sets 462 and 464 and transmits the RACH preamble 468 in the first RACH resource set 462 and again in the second RACH resource set 464 during a time period before the UE expects receiving an RA response.

Responsive to the RACH preambles 468, the UE receives the RA response RA 2 including two coresets having two DCIs. In accordance with other embodiments responsive to transmitting the preambles 468 twice, the gNB may only returns a single coreset with one DCI in the RA response RA2.

Thus, by means of the inventive approach in accordance with the third aspect of the present invention, the RACH preamble 468 for a low power UE, like a RedCap UE, or for a regular UE with a reduced coverage, is sent more than once—in the embodiment depicted in FIG. 9. It is transmitted twice—so that the receiver, like the base station 404 may combine the signal 468 which, in combination, despite the reduced power by which they are sent or despite the reduced coverage of the UE, they may be decodable by the base station so that the RACH procedure also for UEs operating on a low transmit power or having a reduced coverage is robust and reliable.

General

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

Although the respective aspects and embodiments of the inventive approach have been described above with reference to a communication between a UE and a base station, e.g., using the Uu interface, it is noted that the present invention is not limited to such embodiments. In accordance with further embodiments, the communication may also between a UE and another UE, e.g., using the sidelink or PC5 interface. The other UE may be a relay node or a relay or a relay-UE. All above described aspects and embodiments may also be implemented for the communication over the PC5 interface. In accordance with such embodiments, the UE may receive the signaling indicating the RACH preamble or the set of RACH preambles associated with the type of the UE by a unicast or groupcast or broadcast message via a sidelink interface, e.g. PC5, from another UE. For example, a smartphone may configure a smartwatch via a SCI, like 1st or 2^{nd} stage SCI, within the PSCCH or via MAC-CE within data within the PSSCH.

In accordance with embodiments, the type of the UE comprises or indicates one or more of:
a UE capability,
a UE supporting a special service, like a reduce capability, RedCap, UE, a Public Protection and Disaster Relief, PPDR, UE, an Internet-of-Things, IoT, UE, an industrial Internet-of-Things, IIoT,
a vehicular UE,
a pedestrian UE,
a relay UE.

In accordance with embodiments, the UE may be a UE that is capable to operate in accordance with one or more capabilities, which are reduced or less when compared to corresponding capabilities of one or more further UEs in the wireless communication network. For example, the UE may be referred to as a reduced capability UE, a RedCap UE, having one or more capabilities being reduced or less than the corresponding capabilities of a further UE, like a URLLC UE or an eMBB UE, also used in the wireless communication network. In accordance with embodiments, the one or more capabilities include one or more of the following:
the UE is capable to operate in a first frequency range or supports a first maximum bandwidth, the first frequency range or first maximum bandwidth being less than a second frequency range or a second maximum bandwidth of the one or more further UEs in the wireless communication network,
the UE supports a first maximum transmit power, the first maximum transmit power being less than a second maximum transmit power of the one or more further UEs in the wireless communication network,
the UE has a first data processing power, the first data processing power being less than a second data processing power of the one or more further UEs in the wireless communication network,
the UE has a first processing time for processing data, like blind decoding of data or processing data received or to be transmitted, the first processing time being longer than a second processing time of the one or more further UEs in the wireless communication network,
the UE has a first power supply capability, the first power supply capability being less than a second power supply capability of the one or more further UEs in the wireless communication network,
the UE has a first data rate/throughput, the first data rate/throughput being less than a data rate/throughput of the one or more further UEs in the wireless communication network,
the UE supports a first number of antennas, the first number of antennas being less than a second number of antennas supported by the one or more further UEs in the wireless communication network; for example, a RedCAP devices may have a reduced number of MIMO features, like only one transmit branch and maybe two receive antennas to do combining so that the RedCap UE supports a smaller number of antennas when compared to a non-RedCap UE.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, an inventive user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, an inventive apparatus comprises one or more of the following: one of the above inventive user devices, a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Embodiments of the present invention provide a wireless communication network, comprising one or more of the inventive user devices, UEs, and/or one or more of the inventive apparatus.

Embodiments of the present invention provide a computer program product comprising instructions which, when the program is executed by a computer, cause the computer to carry out one or more methods in accordance with the present invention.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 10 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein.

The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above described embodiments are merely illustrative for the principles of the present invention. It is understood that modifications and variations of the arrangements and the details described herein are apparent to others skilled in the art. It is the intent, therefore, to be limited only by the scope of the impending patent claims and not by the specific details presented by way of description and explanation of the embodiments herein.

1. A device comprising:
a processor circuit; and
a memory circuit, wherein the memory comprises instructions executable by the processor circuit,
wherein the processor circuit is arranged to signal a type of user equipment during a random access channel procedure.

2. The device of claim 1,
wherein the processor circuit is arranged is to send a random access channel message at least twice.

3. The device of claim 2,
wherein the processor circuit is arranged to send a random access channel message at least twice during a time period,
wherein the processor circuit does not expect a response to the random access channel message during the time period.

4. The device of claim 2,
wherein the processor circuit is arranged to send the random access channel message in a domain,
wherein the domain is selected from the group consisting of the time domain, the frequency domain, the space domain and the code domain.

5. The device of claim 2,
wherein the random access channel message is a random access channel preamble,
wherein the processor circuit is arranged to obtain at least one of a plurality of random access channel resource,
wherein the processor circuit is arranged to send the random access channel preamble more than once using at least one of the plurality of random access channel resource sets.

6. The device of claim 2,
wherein the certain random access channel message comprises a random access channel preamble,
wherein the random access channel is associated with the type of user equipment.

7. The device of claim 6,
wherein the processor circuit is arranged to select the random access channel preamble from a plurality of random access channel RACH preambles,
wherein the plurality of random access channel preambles is associated with the type of user equipment.

8. The device of claim 7,
wherein the random access channel RACH preamble or the plurality of random access channel preambles is predefined,
wherein the processor circuit is arranged to receive an indication of the random access channel RACH preamble or the plurality of random access channel preambles.

9. The device of claim 2, wherein the random access channel procedure is a four-step random access channel procedure or a two-step random access channel procedure.

10. The device of claim 2,
wherein the random access channel procedure is a two-step random access channel procedure,
herein the processor circuit is arranged to include an indication of the type of user equipment into a message,
wherein the message is a portion of the two-step random access channel procedure.

11. The device of claim 1, wherein the type of user equipment indicates at least one of user equipment capability, a user equipment support for a special service, a vehicular user equipment, a pedestrian user equipment, and a relay user equipment.

12. The device of claim 1,
wherein the type of user equipment indicates that the user equipment has a least one capability,
wherein the at least one capability is less than corresponding capabilities of at least one second user equipment.

13. The device of claim 12,
wherein the at least one capability are selected from the group consisting of a capability of operating in a first frequency range, supporting a first maximum bandwidth, supporting a first maximum transmit power, a first data processing power, a first processing time, a first power supply capability, supporting a first number of antennas,
wherein the first frequency range is less than a second frequency range,
wherein a second user equipment operates in the second frequency range,
wherein the first maximum bandwidth is less than a second maximum bandwidth,
wherein the second user equipment operates in the second bandwidth,
wherein the first maximum transmit power is less than a second maximum transmit power,
wherein the second user equipment has the second maximum transmit power,
wherein the first data processing power is less than a second data processing power,
wherein the second user equipment has the second data processing power,
wherein the first processing time is longer than a second processing time,
wherein the second user equipment has the second processing time,
wherein the first power supply capability is less than a second power supply capability,
wherein the second user equipment has the second power supply capability,
wherein the first number of antennas is less than a second number of antennas supported by the one or more further UEs in the wireless communication network.

14. A device comprising:
a processor circuit; and
a memory circuit, wherein the memory comprises instructions executable by the processor circuit,
wherein the processor circuit is arranged to send a random access channel message at least twice during a random access channel procedure.

15. The device of claim 14,
wherein the processor circuit is arranged to send the random access channel message at least twice during a time period,
wherein the processor circuit does not expect a response to the random access channel message during the time period.

16. The device of claim 14,
wherein the processor circuit is arranged to monitor at least one control channel(s) for a control message, after sending the second random access channel message,
wherein the control message is scrambled with an Radio Network Temporary Identifier for the random access channel procedure.

17. The device of claim 14,
wherein the processor circuit is arranged to support a first maximum transmit power,
wherein the first maximum transmit power is less than a second maximum transmit power,
wherein a second user equipment supports the second maximum transmit power.

18. The device of claim 14, wherein processor circuit is arranged to repeat the random access channel message in at least one of a time domain, a frequency domain, a space domain and a code domain.

19. The user device, UE, of claim 14,
wherein the random access channel message is a random access channel preamble,
wherein the processor circuit is arranged to obtain at least one of a plurality of random access channel resource(s),
wherein the processor circuit is arranged to send the random access channel preamble more than once using the at least one of the plurality of random access channel resource(s).

20. The device of claim 19,
wherein the processor circuit is arranged to receive a signaling,
wherein the signal indicates at least one of the plurality of random access channel resource(s).

21. The device of claim 14,
wherein the device is able to operate in accordance with at least one capability,
wherein the at least one capability is less than corresponding capabilities of at least one second user equipment.

22. The device of claim 21,
wherein the at least one capability is selected from the group consisting of operating in a first frequency range, supporting a first maximum bandwidth, having a first data processing power,
having a first processing time
having a first power supply capability supporting a first plurality of antennas,
wherein the first frequency range is less that a second frequency range,
wherein a second user equipment supports the second frequency range,
wherein the first maximum bandwidth is less that a second maximum bandwidth,
wherein the second user equipment supports the second maximum bandwidth,
wherein the first data processing power is less that a second data processing power,
wherein the second user equipment has the second data processing power,
wherein the first data processing time is less that a second data processing time,
wherein the second user equipment has the second data processing time,
wherein the first power supply capability is less that a second power supply capability,
wherein the second user equipment has the second power supply capability,
wherein the first number of antennas is less than a second number of antennas,
wherein the second user equipment supports the second number of antennas.

23. (canceled)

24. An apparatus comprising:
a processor circuit; and
a memory circuit, wherein the memory comprises instructions executable by the processor circuit,
wherein the processor circuit is arranged to determine if the a user equipment is of a type during a random access channel procedure.

25. The apparatus of claim 24,
wherein the processor circuit is arranged to determine that the user equipment is responsive to receiving at least n transmissions of a random access channel message,
wherein n is an integer greater than 1.

26. The apparatus of claim 25,
wherein the first access channel message comprises a random access channel preamble,
wherein the random access channel is associated with the type.

27. The apparatus of claim 26,
wherein the processor circuit is arranged to select the random access channel preamble from a plurality of random access channel preambles,
wherein the plurality of random access channel preambles is associated with the type.

28. The apparatus of claim 26,
wherein the random access channel preamble or the plurality of random access channel preambles associated with the type is predefined, or.

29. The apparatus of claim 24,
wherein the random access channel procedure is a two step random access channel procedure,
wherein the processor circuit is arranged to extend a timing between MsgA and MsgB in response to receiving an indication of the.

30. The apparatus of claim 24, wherein the processor circuit is arranged to to increase a time gap between sending a control message and sending associated data.

31. The apparatus of claim 24, wherein the processor circuit is arranged to increase a time gap between sending a control message and an associated grant for a transmission.

32. The apparatus of claim 24,
wherein the processor circuit is arranged to indicate a grant or data such that the data can be transmitted or processed by the user equipment or by second user equipment,
wherein the second user equipment is not of the type.

33. The apparatus of claim 24,
wherein the processor circuit is arranged to indicate at least two grants or at least two data allocations when the type is not determined,
wherein the user equipment can transmit or process data associated with one of the grants or data allocations,
wherein a third user equipment is of a different type,
wherein the third use equipment can transmit or process data associated with a third grant or a third data allocation.

34. An apparatus comprising:
a processor circuit; and
a memory circuit, wherein the memory comprises instructions executable by the processor circuit,
wherein the processor circuit is arranged to determine if a user equipment is of a type in response to a transmission between the apparatus and the user equipment.

35. The apparatus of claim 34,
wherein the transmission is from the user equipment to the apparatus,
wherein the processor circuit is arranged to send an indication of the at least two,
wherein the processor circuit is arranged to determine if the user equipment is of the type.

36. The apparatus of claim 34,
wherein the at least two grants comprises a UL grant or a SL grant,
wherein the UL grant or SL grant are associated with respective processing times,
wherein the processing times comprise a first processing time for the user equipment of a first type and a second processing time for the user equipment of a user equipment of a second type.

37. The apparatus of claim 34,
wherein the transmission is from the apparatus to the user equipment,
wherein the processor circuit is arranged to send to first data and second data to the user equipment,
wherein the processor circuit is arranged determine if the user equipment is of the type based on timing of a feedback.

38. The apparatus of claim 34,
wherein the transmission is from the apparatus to the user equipment,
wherein the processor circuit is arranged to send UE data,
wherein the processor circuit is arranged determine if the user equipment is of the type based on a timing of a feedback.

39. The apparatus of claim 34,
wherein the type indicates that the user equipment is capable to operate in accordance with at least one capability,
wherein the at least one capability is less than a corresponding capabilities of at least one second user equipment.

40. The apparatus of claim 39,
wherein the at least one capability is selected from the group consisting of operating in a first frequency range, supporting a first maximum bandwidth, supporting a first maximum transmit power, a first data processing power, a first processing, a first power supply capability, and supporting a first number of antennas,
wherein the first frequency range is less than a second frequency range,
wherein a second user equipment has the second frequency range,
wherein the first maximum bandwidth is less than a second maximum bandwidth,
wherein second equipment has the second maximum bandwidth,
wherein the first maximum transmit power is less than a second maximum transmit power,
wherein second equipment has the second maximum transmit power,
wherein the first data processing power is less than a second data processing power,
wherein second equipment has the second data processing power,
wherein the first processing time is longer than a second processing time,
wherein the second user equipment has the second processing time,
wherein the first power supply capability is less than a second power supply capability,
wherein the second user equipment has the second power supply capability,
wherein the first number of antennas is less than a second number of antennas,
wherein the second equipment supports the second number of antennas.

41. (canceled)

42. (canceled)

43. A method for operating a device comprising:
signaling a type of user equipment during a random access channel procedure; and
sending at least two random access channel message(s) during the random access channel procedure.

44. (canceled)

45. A method for operating an apparatus comprising:
determining if a user equipment is of a certain type during a random access channel procedure; and
receiving at least two random access channel message(s) during the random access channel procedure.

46. A method for operating an apparatus comprising:
determining if a user equipment is of a certain type in response to a transmission between the apparatus and the user equipment; and
receiving at least two random access channel message(s).

47. A computer program stored on non-transitory, wherein the computer program when executed on a processor performs the method as claimed in claim 43.

48. A computer program stored on a non-transitory medium, wherein the computer program when executed on a processor performs the method as claimed in claim 45.

49. A computer program stored on a non-transitory medium, wherein the computer program when executed on a processor performs the method as claimed in claim 46.

50. The device of claim 1,
wherein the processor circuit is arranged to send an associated random access channel message,
wherein the associated random access channel is associated with the type of user equipment.

51. The device of claim 1,
wherein the processor circuit is arranged to send a type random access channel message,
wherein the type random access channel comprises an indication of the type of user equipment.

52. The apparatus of claim 24,
wherein the processor circuit is arranged to determine if a first random access channel message is associated with the type.

53. The apparatus of claim 24,
wherein the processor circuit is arranged to determine if a second random access channel message comprises information indicating the type.

54. The apparatus of claim 26,
wherein the processor circuit is arranged to receive an indication the random access channel preamble or the plurality of random access channel preambles associated with the type.
